(19) United States
(12) Patent Application Publication
(10) Pub. No.: US 2024/0341279 A1
(43) Pub. Date: Oct. 17, 2024

(54) Animal Interaction Deterrent Collar System

(71) Applicant: Vernon Ames, Sloan, IA (US)

(72) Inventor: Vernon Ames, Sloan, IA (US)

(21) Appl. No.: 18/508,502

(22) Filed: Nov. 14, 2023

Related U.S. Application Data
(60) Provisional application No. 63/495,325, filed on Apr. 11, 2023.

(51) Int. Cl. A01K 27/00

(52) U.S. Cl. CPC A01K 27/001; A01K 27/009

(57) ABSTRACT

An animal interaction deterrent collar system is provided. The system is primarily comprised of two collars, each with a deterrent module, that can be worn by any animal or human. A signal between the two collars can determine the distance between the two collars, allowing a method of deterrent determined by a function button, such as a shock, vibration, sound, or light, to be sent to one or both wearers of the collars. A mode button may be toggled to identify a more aggressive animal such that the method of deterrent would only be sent to the collar of the more aggressive animal.

### CROSS-REFERENCE TO RELATED APPLICATION

The present application claims priority to, and the benefit of, U.S. Provisional Application No. 63/495,325, which was filed on Apr. 11, 2023, and is incorporated herein by reference in its entirety.

### FIELD OF THE INVENTION

The present invention relates generally to the field of animal shock collars. More specifically, the present invention relates to an animal interaction deterrent collar system comprised of two collars, each with a deterrent module, that can be worn by any animal or human. A signal between the two collars can determine the distance between the two collars, allowing a method of deterrent determined by a function button, such as a shock, vibration, sound, or light, to be sent to one or both wearers of the collars. Accordingly, the present disclosure makes specific reference thereto. Nonetheless, it is to be appreciated that aspects of the present invention are also equally applicable to other like applications, devices, and methods of manufacture.

### BACKGROUND

When multiple animals co-exist in the same household, many problems may arise. For example, one animal may be aggressive toward another animal, leading to potential attacks and injuries of the more passive animal. Undesired breeding may also occur when animals are kept in very close quarters for long periods of time. Even humans may be at risk of attack and injuries when co-existing with an animal, especially infants and younger children that may not know how to behave when around an animal.

Therefore, there exists a long-felt need in the art for a system that can prevent a more aggressive animal from injuring a more passive animal or human. More specifically, there exists a long-felt need in the art for an animal interaction deterrent collar system that can determine the distance between two animals or an animal and a human and prevent an aggressive animal from getting too close to the other. Furthermore, there exists a long-felt need in the art for an animal interaction deterrent collar system that can be easily worn by an animal or a human in a comfortable manner.

The subject matter disclosed and claimed herein, in one embodiment thereof, comprises an animal interaction deterrent collar system. The system is primarily comprised of two collars, each with a deterrent module, that can be worn by any animal or human. A signal between the two collars can determine the distance between the two collars, allowing a method of deterrent determined by a function button, such as a shock, vibration, sound, or light, to be sent to one or both wearers of the collars. A mode button may be toggled to identify a more aggressive animal such that the method of deterrent would only be sent to the collar of the more aggressive animal. A mobile application may further configure the intensity and frequency of the methods of a deterrent.

In this manner, the animal interaction deterrent collar system of the present invention accomplishes all the foregoing objectives and provides a system that prevents a more aggressive animal from injuring a more passive animal or human. More specifically, the animal interaction deterrent collar system determines the distance between two animals or an animal and a human and sends a signal to the more aggressive animal to prevent the animal from getting within a specified distance from the other. Furthermore, the animal interaction deterrent collar system resembles a comfortable collar to be worn by an animal or a comfortable bracelet to be worn by a human.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal interaction deterrent collar system primarily comprised of a collar, a deterrent module, and a mobile application. The system is designed to be used with at least two collars that, when worn by animals or a combination of animals and humans, can send a signal to a more aggressive animal to prevent the animal from getting close to the animal or human wearing the other collar.

The system is comprised of a collar that may be worn around the neck of an animal or the wrist or ankle of a human. The collar may be comprised of an adjustment fastener to accommodate differing sizes of individual animals and humans. The collar may further be comprised of a fastener that can attach to the fastener of a deterrent module such that the deterrent module may be removably attached to the collar.

The deterrent module is comprised of a transmitter and a receiver that allows the deterrent module of one collar to communicate with the deterrent module of another collar. The signal sent between the transmitter and the receiver of the two deterrent modules allows a processor to determine the distance between the two deterrent modules. If the deterrent modules get too close to one another, a method of deterrent as determined by toggling a function button, such as a shock, a vibration, a flash of light, or a sound, may be produced to indicate to one or both wearers of the collar to separate. A mode button may be toggled to determine which collar or collars use the method of deterrent on the wearer or wearers.

The system may further be comprised of a mobile application which is comprised of an alert user function and a configure module function. The alert user function allows the mobile application to alert a user if the two wearers of the system come within a distance specified by the configure module function. The configure module function may also customize the intensity or frequency of the method of a deterrent.

The present invention is also comprised of a method of using the system. First, a system is provided primarily comprised of at least two collars, each with a deterrent module, and a mobile application. Then, one collar is placed on a first animal/human. Then, another collar is placed on a second animal/human. Next, a user can use the mode button to set the deterrent module of the first animal/human to the “aggressive pet” mode. Then, a user can use the mode button to set the deterrent module of the second animal/human to the “passive pet” or “passive person” mode. Then, a user can use the mobile application to configure the settings of the receiver of the deterrent module of the second animal/human to determine at what distance between the first animal/human and the second animal/human the deterrent module of the first animal/human activates. Finally, a user can use the mobile application to configure the settings of the electrode, the vibrating motor, the lights, and the speaker of the deterrent module of the first animal/human.

Accordingly, the animal interaction deterrent collar system of the present invention is particularly advantageous as it provides a system that prevents a more aggressive animal from injuring a more passive animal or human. More specifically, the animal interaction deterrent collar system can be comfortably worn around the neck of an animal or the wrist or ankle of a human. Furthermore, the animal interaction deterrent collar system can calculate the distance between two animals or an animal and a human and send a signal to a more aggressive pet to prevent the animal from getting within a specified distance of the other animal or human. In this manner, the animal interaction deterrent collar system provides a solution to prevent two animals or humans from interacting.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal interaction deterrent collar system of the present invention in accordance with the disclosed architecture;

FIG. 2 illustrates an enhanced perspective view of a mode button of one potential embodiment of an animal interaction deterrent collar system of the present invention in accordance with the disclosed architecture;

FIG. 3 illustrates an enhanced perspective view of a function button of one potential embodiment of an animal interaction deterrent collar system of the present invention in accordance with the disclosed architecture;

FIG. 4 illustrates a perspective view of one potential embodiment of an animal interaction deterrent collar system of the present invention while worn by a first human or animal in accordance with the disclosed architecture;

FIG. 5 illustrates a perspective view of one potential embodiment of an animal interaction deterrent collar system of the present invention while worn by a second human or animal in accordance with the disclosed architecture;

FIG. 6 illustrates a graphical view of features of a mobile application of one potential embodiment of an animal interaction deterrent collar system of the present invention in accordance with the disclosed architecture; and

FIG. 7 illustrates a flowchart of a method of using one potential embodiment of an animal interaction deterrent collar system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can prevent a more aggressive animal from injuring a more passive animal or human. More specifically, there exists a long-felt need in the art for an animal interaction deterrent collar system that can determine the distance between two animals or an animal and a human and prevent an aggressive animal from getting too close to the other. Furthermore, there exists a long-felt need in the art for an animal interaction deterrent collar system that can be easily worn by an animal or a human in a comfortable manner.

The present invention, in one exemplary embodiment, is comprised of an animal interaction deterrent collar system. The system is primarily comprised of a collar, a deterrent module, and a mobile application. The system is designed to be used with at least two collars that, when worn by animals or a combination of animals and humans, can send a signal to a more aggressive animal to prevent the animal from getting close to the animal or human wearing the other collar.

More specifically, the system is comprised of a collar that is preferably made from a material that is prone to easily tearing. The collar may be any wearable hoop-like object known in the art such that it may be worn by any animal or human. The collar is further comprised of an adjustment fastener, a leash clip, and a fastener. The adjustment fastener may allow for the length of the collar to change to accommodate different sizes of animals or humans from which the collar is to be worn. In the embodiment in which the collar is to be worn by an animal, a leash clip may be attached to the collar such that the collar may be used as a normal animal collar. The fastener may allow a deterrent module to be removably attached to the collar.

The deterrent module is comprised of a fastener that allows the deterrent module to attach to the fastener of the collar. The deterrent module is further comprised of a transmitter and a receiver that allows the deterrent module of the collar of a first animal/human to communicate with the deterrent module of another collar worn by a second animal/human. The transmitter and receiver send signals that communicate the distance between the two collars. An electrode, a vibrating motor, a light, or a speaker may be activated when the deterrent module of a first animal/human gets close to the deterrent module of a second animal/human, preventing the two deterrent modules from getting too close to one another.

The deterrent module may be further comprised of a mode button that allows for only one of the collars of the system to signal to the wearer to not approach the wearer of the other collar any further. The mode button may determine if the deterrent module is transmitting a signal via the transmitter or receiving a signal via the receiver. If the first animal/human is more aggressive than the second animal/human, the mode button may be set to transmit a signal on the first animal/human and receive a signal on the second animal/human. A function button may then send a signal to a processor that signals to the deterrent module whether to shock, vibrate, emit light, or produce sound from the deterrent module of the first animal/human on which the mode button has been set to the transmitting function.

The system is also comprised of a battery and a charging port that allows the system to power all electrical components of the system. The battery may be any type of battery known in the art but is preferably a rechargeable battery internal to the system. The charging port may be any charging port type to accept any charging cord known in the art in differing embodiments. The system may further be comprised of a mobile application. The mobile application may be further comprised of an alert user function and a configure module function. The alert user function may allow the mobile application to alert the user, via a push notification, text, email, etc., when the first animal/human gets close to the second animal/human. The configure module function allows the user to customize the deterrent method of choice for the more aggressive animal/human. The configure module may allow for the customization of the shock intensity of the electrode, the intensity of the vibrating motor, the brightness and flashing of the lights, and the output of the speaker. The configure module may also allow the user to set the distance between the first animal/human and the second animal/human from when the deterrent module will activate the electrode, vibrating motor, lights, or speaker to prevent the first animal/human from getting close to the second animal/human.

The present invention is also comprised of a method of using the system. First, a system is provided primarily comprised of at least two collars, each with a deterrent module, and a mobile application. Then, one collar is placed on a first animal/human. Then, another collar is placed on a second animal/human. Next, use the mode button to set the deterrent module of the first animal/human to the “aggressive pet” mode. Then, a user can use the mode button to set the deterrent module of the second animal/human to the “passive pet” or “passive person” mode. Then, a user can use the mobile application to configure the settings of the receiver of the deterrent module of the second animal/human to determine at what distance between the first animal/human and the second animal/human the deterrent module of the first animal/human activates. Finally, a user can use the mobile application to configure the settings of the electrode, the vibrating motor, the lights, and the speaker of the deterrent module of the first animal/human.

Accordingly, the animal interaction deterrent collar system of the present invention is particularly advantageous as it provides a system that prevents a more aggressive animal from injuring a more passive animal or human. More specifically, the animal interaction deterrent collar system can determine the distance between two wearers of the system and send a signal to one or both wearers that prevent the wearers from getting within a specified distance of one another. Furthermore, the animal interaction deterrent collar system is adjustable such that it may be comfortably worn around the neck, wrist, or ankle of any animal or human. In this manner, the animal interaction deterrent collar system provides a solution to prevent two animals or humans from interacting.

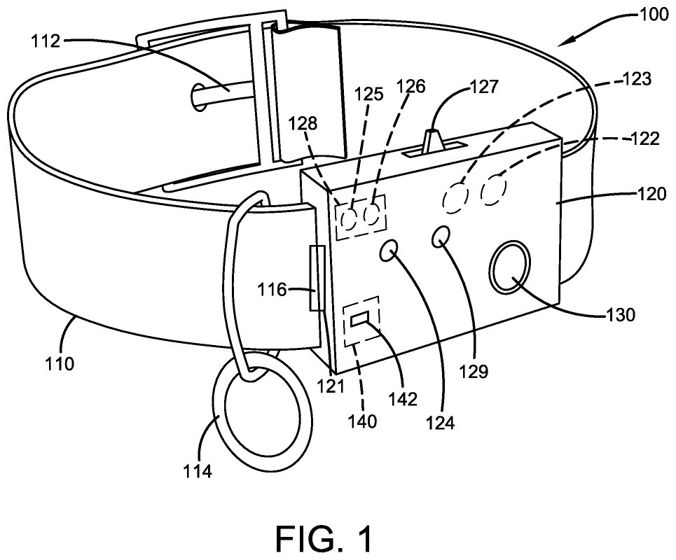

Referring initially to the drawings, FIG. 1 illustrates a perspective view of one potential embodiment of an animal interaction deterrent collar system 100 of the present invention in accordance with the disclosed architecture. The system 100 is primarily comprised of at least one collar 110 with at least one deterrent module 120, and a mobile application 150. The system 100 is designed to be used with at least two collars 110 that, when worn by animals or a combination of animals and humans, can send a signal to a first animal to prevent the animal from getting close to a second animal (or human) wearing the other collar 110.

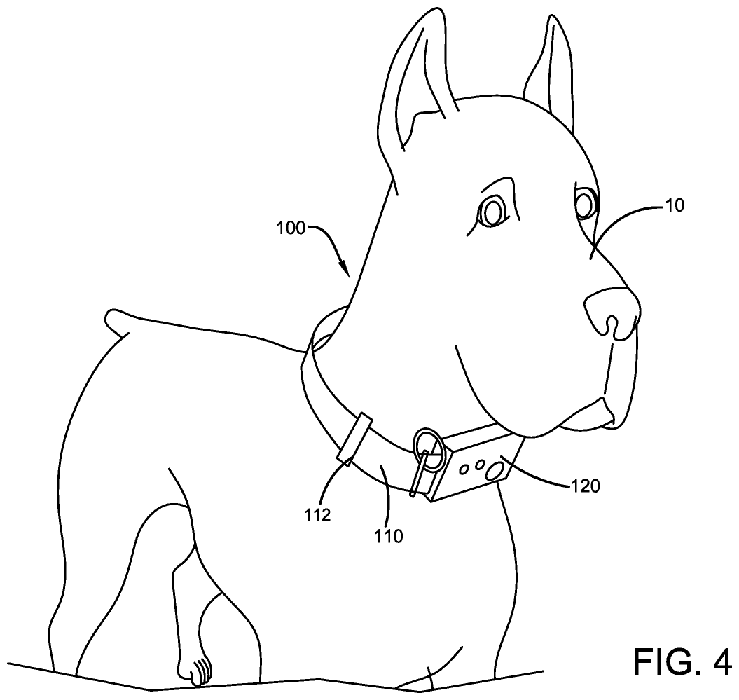

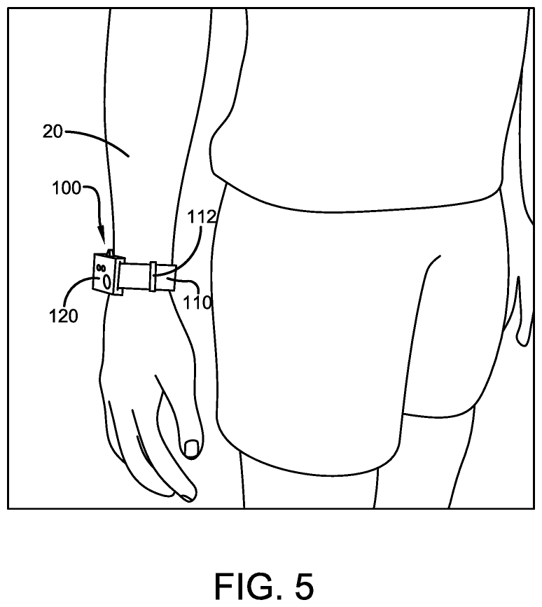

The system 100 is comprised of a collar 110 that is preferably made from a durable fabric material that does not easily tear. The collar 110 may be any wearable hoop-like object typically worn by an animal or a human, as seen in FIGS. 4 and 5, such as, but not limited to, a dog collar, a choker, a bracelet, a necklace, a cuff, a harness, etc. The collar 110 may be further comprised of at least one adjustment fastener 112 and at least one fastener 116. The adjustment fastener 112 may be any clip, loop, buckle, etc., that allows the circumference of the collar 110 to be increased or decreased to accommodate various-sized animals and humans. In one potential embodiment, the collar 110 may be further comprised of at least one leash clip 114 such that the collar 110 may be used as a typical animal collar when not attempting to prevent the animal from getting close to another specific animal. The fastener 116 may be any reciprocating fastener known in the art that allows a deterrent module 120 to removably attach to the collar 110 such that the module 120 can be removed when not in use.

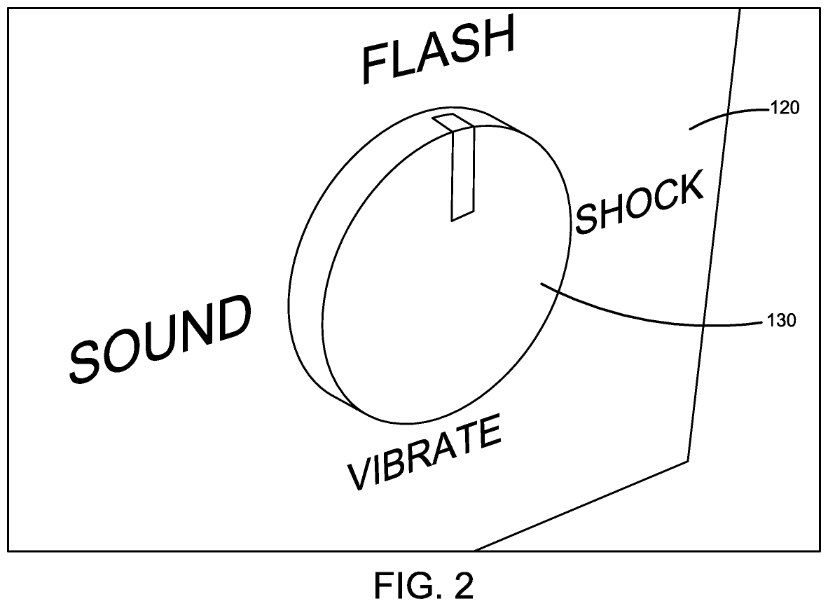

FIG. 2 illustrates an enhanced perspective view of a mode button 127 of one potential embodiment of an animal interaction deterrent collar system 100 of the present invention in accordance with the disclosed architecture. The deterrent module 120 is comprised of at least one fastener 121 that may attach to the fastener 116 of the collar 110. The fasteners 116,121 may be any reciprocating fasteners known in the art, such as hook-and-loop fasteners, snap-fit fasteners, clip-on fasteners, etc. The deterrent module 120 of the collar 110 is further comprised of at least one transmitter 125 and at least one receiver 126. When used with another collar 110, the transmitter 125 of a first deterrent module 120 of a first collar 110 may send a signal which may be received by the receiver 126 of the second deterrent module 120 of the second collar 110. The signal sent between the transmitter 125 and the receiver 126 may be configured by a processor 128 to determine the threshold distance between the two collars 110. Once the threshold distance (ex. 3 feet) is exceeded, the signal is sent between collars 110 to deliver a vibration, shock, etc., from the module 120 to the first animal. A mode button 127 may be toggled to determine whether the deterrent module 120 transmits or receives the signal. It is preferred that a passive animal or human's module 120 is set to transmit a signal and the aggressive animal's module 120 receives the signal, or vice versa.

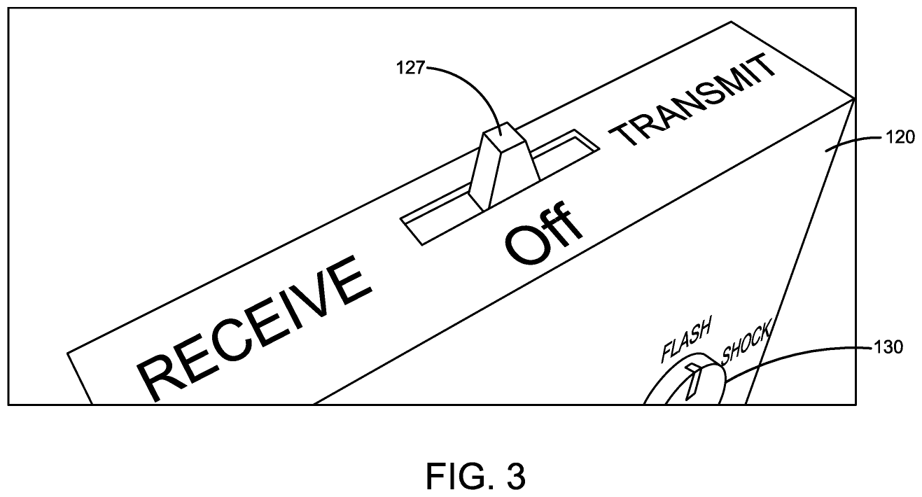

FIG. 3 illustrates an enhanced perspective view of a function button 130 of one potential embodiment of an animal interaction deterrent collar system 100 of the present invention in accordance with the disclosed architecture. The deterrent module 120 is also comprised of a function button 130 that determines the correction method used by the module 120 to prevent a first animal/human 10 from getting close to a second animal/human 20. The function button 130 may toggle between at least four functions that allow the collar 110 to flash, shock, vibrate, or emit a sound. The deterrent module 120 is thus comprised of at least one electrode 122 to provide a shock to the wearer, which may have a plurality of shock intensity levels. At least one vibrating motor 123 of the module 120 may be used to vibrate the collar 110, wherein the motor 123 may have a plurality of vibration intensity levels. At least one light 124 may flash, wherein the light 124 has a plurality of brightness levels. At least one speaker 129 may emit a sound, wherein the speaker is comprised of a plurality of volume levels. Each method may be used simultaneously, separately, or in sequence with one another. The mode button 127 may additionally be toggled between an “aggressive pet” function and a “passive pet” or “passive human” function that only allows the methods of deterrent of the module 120 to be used on the more aggressive animal wearing the pair of collars 110.

The system 100 is also comprised of at least one battery 140 that is preferably rechargeable and internal to the system 100. The battery 140 may be a disposable battery or a rechargeable battery in the form of an alkaline, nickel-cadmium, nickel-metal hydride battery, etc., such as any 3V-12 volts DC battery or other conventional battery such as A, AA, AAA, etc., that supply power to the system 100. Throughout this specification, the term “battery” may be used interchangeably to refer to one or more wet or dry cells or batteries of cells in which chemical energy is converted into electricity and used as a source of DC power. References to recharging or replacing the battery 140 may refer to recharging or replacing individual cells, individual batteries of cells, or a package of multiple battery cells as is appropriate for any given battery technology that may be used. The battery 140 may receive power via a charging port 142. The charging port 142, in differing embodiments, may be able to interface with any charging cord known in the art but is preferably USB compatible.

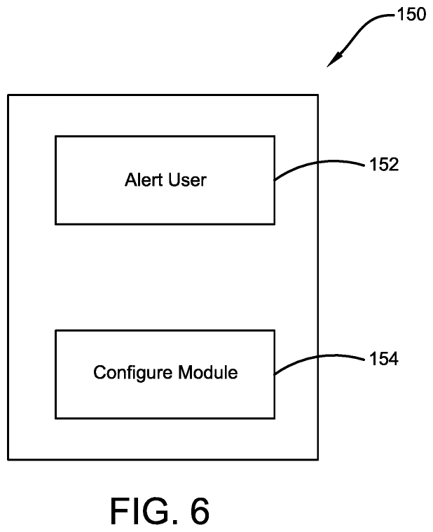

FIG. 6 illustrates a graphical view of features of a mobile application 150 of one potential embodiment of an animal interaction deterrent collar system 100 of the present invention in accordance with the disclosed architecture. The system 100 may further be comprised of a mobile application 150. The mobile application 150 may further be comprised of an alert user function 152 and a configure module function 154. The alert user function 152 may allow the mobile application 150 to alert the user via a push notification on a smart device, a text, an email, etc., when the first animal/human 10 exceeds the programmable threshold distance to the second animal/human 20. The configure module function 154 may allow the user to customize the method of deterrent of the deterrent module 120. The configure module function 154 may allow for the customization of the shock intensity from the electrode 122, the vibration intensity from the vibrating motor 123, the brightness and speed of flashing of the light 124, and the sound level emitted by the speaker 129. The configure module 154 may further allow the user to customize at what threshold distance between the first animal/human 10 and the second animal/human 20 method of deterrent occurs.

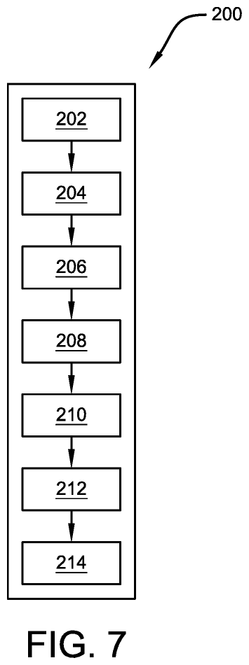

The present invention is also comprised of a method 200 of using the system 100, as seen in FIG. 7. First, a system 100 is provided primarily comprised of at least two collars 110, each with at least one deterrent module 120, a receiver 126 and/or transmitter 125, and a mobile application 150 [Step 202]. Then, a first collar 110 is placed on a first animal/human 10 [Step 204]. Next, a second collar 110 is placed on a second animal/human 20 [Step 206]. Then, the mode button 127 of the first collar 10 is toggled to set the deterrent module 120 of the first collar 10 to the “aggressive pet” mode [Step 208]. Then, the mode button 127 is toggled to set the deterrent module 120 of the second collar to the “passive pet” or “passive person” mode [Step 210]. Then, a user can use the mobile application 150 to configure a threshold distance which, when exceeded, will activate the module 120 of the first collar 110 [Step 212]. Finally, a user can use the mobile application 150 to configure the settings of the electrode 122, the vibrating motor 123, the lights 124, and the speaker 129 of the deterrent module 120 of the first animal/human 10 [Step 214].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “animal interaction deterrent collar system” and “system” are interchangeable and refer to the animal interaction deterrent collar system 100 of the present invention.

Notwithstanding the foregoing, the animal interaction deterrent collar system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal interaction deterrent collar system 100 as shown in the FIGS. are for illustrative purposes only, and that many other sizes and shapes of the animal interaction deterrent collar system 100 are well within the scope of the present disclosure. Although the dimensions of the animal interaction deterrent collar system 100 are important design parameters for user convenience, the animal interaction deterrent collar system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal interaction deterrent collar system comprising:
a collar; and
a deterrent module attached to the collar, the deterrent module comprised of a button and a battery.

2. The animal interaction deterrent collar system of claim 1, wherein the deterrent module is comprised of an electrode.

3. The animal interaction deterrent collar system of claim 1, wherein the deterrent module is comprised of a vibrating motor.

4. The animal interaction deterrent collar system of claim 1, wherein the deterrent module is comprised of a light.

5. The animal interaction deterrent collar system of claim 1, wherein the deterrent module is comprised of a speaker.

6. The animal interaction deterrent collar system of claim 1, wherein the deterrent module is comprised of a transmitter or a receiver.

7. An animal interaction deterrent collar system comprising:
a collar;
a deterrent module attached to the collar, the deterrent module comprised of a button and a battery; and
a mobile application.

8. The animal interaction deterrent collar system of claim 7, wherein the deterrent module is comprised of a transmitter and a receiver.

9. The animal interaction deterrent collar system of claim 8, wherein the transmitter or the receiver is comprised of a threshold distance.

10. The animal interaction deterrent collar system of claim 9, wherein the deterrent module is activated when the threshold distance is exceeded.

11. The animal interaction deterrent collar system of claim 8, wherein the button can be used to select whether the transmitter or the receiver is active.

12. The animal interaction deterrent collar system of claim 7, wherein the mobile application is in wireless communication the deterrent module.

13. The animal interaction deterrent collar system of claim 7, wherein the collar is comprised of a bracelet.

14. The animal interaction deterrent collar system of claim 7, wherein the collar is comprised of an adjustment fastener.

15. The animal interaction deterrent collar system of claim 7, wherein the collar is comprised of a leash clip.

16. The animal interaction deterrent collar system of claim 7, wherein the battery is comprised of a charging port.

17. The animal interaction deterrent collar system of claim 7, wherein a first fastener of the collar attaches to a second fastener of the deterrent module.

18. A method of using an animal interaction deterrent collar system, the method comprising the following steps:
providing an animal interaction deterrent collar system comprised of a first collar comprised of a first deterrent module and a transmitter and a second collar comprised of a second deterrent module and a receiver;
placing the first collar on a first animal or a first human;
placing the second collar on a second animal or a second human;
setting the first deterrent module to a first mode;
setting the second deterrent module to a second mode; and
configuring a threshold distance that when exceeded activates the first deterrent module.

19. The method of using an animal interaction deterrent collar system of claim 18, wherein the deterrent module is comprised of an electrode, a vibrating motor, a light, or a speaker.

20. The method of using an animal interaction deterrent collar system of claim 18 further comprised of a mobile application.
